(19) United States
(12) Patent Application Publication
(10) Pub. No.: US 2010/0237759 A1
(43) Pub. Date: Sep. 23, 2010

(54) Plasma tube array-type display sub-module and display device

(75) Inventors: Yoshio Shibukawa, Kobe (JP); Koji Shinohe, Kobe (JP); Tetsuya Makino, Kobe (JP); Hitoshi Hirakawa, Kobe (JP); Kenji Awamoto, Kobe (JP)

Correspondence Address: STAAS & HALSEY LLP, SUITE 700, 1201 NEW YORK AVENUE, N.W., WASHINGTON, DC, 20005, US

(73) Assignee: SHINODA PLASMA CO., LTD., Kobe-shi (JP)

(21) Appl. No.: 12/656,940

(22) Filed: Feb. 19, 2010

(30) Foreign Application Priority Data
Mar. 19, 2009 (JP) 2009-68099

(51) Int. Cl. H01J 17/49

(52) U.S. Cl. 313/1

(57) ABSTRACT

A plasma tube array-type display sub-module commonized to allow a universal design, and a large-screen display device configured with the plural PTA sub-modules are easily provided. A front-side supporting sheet is provided, on front face of a plasma tube array with a plurality of display electrode pairs in which X and Y electrodes extend in the direction intersecting the plasma tubes. At both ends of the front-side supporting sheet, connection boards are provided in which an X connector connected to the X electrode and a Y connector connected to the Y electrode are provided separately in the direction in which the display electrode pairs extend. A flexible cable connects between the same type of connectors of the adjacent PTA sub-modules and thereby the PTA sub-modules are joined together.

### BACKGROUND OF THE INVENTION

1. Field of the Invention

The present invention relates to a large-screen display device configured with a plurality of plasma tube array-type display sub-modules connected to one another. More particularly, the present invention relates to a display device in which the plasma tube array-type display sub-modules that compose a plasma tube array-type display system module are commonized to be attachable or detachable.

2. Description of the Related Art

Plasma tube array-type display sub-modules (hereinafter referred to as “PTA sub-modules”) have been developed as a technology for providing new-generation large-screen display devices. The PTA sub-modules each include a plurality of plasma tubes filled with a discharge gas that are arranged in parallel. For example, a plasma tube array-type display system module (hereinafter referred to as a “PTA system module”) in which a plurality of PTA sub-modules, each of which is one meter square, are connected to one another can be used to construct a large-screen display device with a size of several meters by several meters. In the case of a display device including a plurality of PTA sub-modules that are connected to one another, it is not necessary to handle a large glass substrate and no large-scale equipment is required as in the case of, for example, LCDs and PDPs. Therefore, a display device with uniform image quality can be provided at a lower cost.

FIG. 1A is a schematic plan view showing a large PTA system module composed of three conventional PTA sub-modules connected laterally to one another. As shown in FIG. 1A, the PTA sub-modules 1 (1a, 1b, and 1c) include display electrodes 10a, 10b, and 10c formed on the inner surface of a front-side flexible supporting sheet in a predetermined arrangement pattern, which are not shown in FIG. 1A, address electrodes formed on the inner surface of a rear-side flexible supporting sheet, which are not shown in FIG. 1A, and address drive circuit boards 11, 11, and 11 connected to the address electrodes (see JP 2004-178854 A).

As the detail of a part thereof is shown in FIG. 1B, in the respective PTA sub-modules 1a, 1b, and 1c, the display electrodes 10a, 10b, and 10c each are configured with a pair of display electrodes for X electrodes and Y electrodes. The PTA sub-module 1a located furthest to the left in the PTA system module is formed in such a manner that display electrodes for common electrodes (X electrodes) 15, 15, . . . and display electrodes for scanning electrodes (Y electrodes) 16, 16, . . . are led out to the same position at the right end of the PTA sub-module 1a, while at the left end, the X electrodes 15 are lead out longer to the left side than the Y electrodes 16 with the lead-out ends serving as X electrode terminals. The X electrode terminals led out longer are connected to an X drive circuit 12 through a connector for the X electrodes.

On the other hand, the PTA sub-module 1c located furthest to the right in the PTA system module is formed in such a manner that X electrodes 15, 15, . . . and Y electrodes 16, 16, . . . are led out to the same position at the left end, while at the right end, the Y electrodes 16 are lead out longer to the right side than the X electrodes 15 with the lead-out ends serving as Y electrode terminals. The Y electrode terminals led out longer are connected to a Y drive circuit 13 through a connector for the Y electrodes. Furthermore, the center PTA sub-module 1b located between the PTA sub-modules 1a and 1c is formed in such a manner that X electrodes 15, 15, . . . and Y electrodes 16, 16, . . . are lead out to the same positions at the left and right ends, with the lengths thereof being the same.

As described above, in the case of the conventional PTA sub-modules 1, 1, . . . , three types of PTA sub-modules 1a, 1b, and 1c comprising the display electrodes 10a, 10b, and 10c, respectively formed in different arrangement patterns are prepared according to the arrangement thereof. These are connected by connectors 14 and 14, so that one PTA system module for a large screen is composed. FIG. 1C is a schematic view showing the state where the display electrodes 10a, 10b, and 10c of three PTA sub-modules 1a, 1b, and 1c are connected laterally to compose one PTA system module.

The connectors 14, each of which connects the PTA sub-modules 1 and 1 to each other, connect the X electrodes and the Y electrodes of the display electrodes 10a, 10b, and 10c bent toward the rear side between adjacent PTA sub-modules 1, 1, . . . together with the front-side flexible supporting sheets FF shown in FIGS. 2A and 2B, to each other according to a corresponding positional relationship. FIGS. 2A and 2B each are a cross-sectional view on the face orthogonal to the longitudinal direction of plasma tubes 17, 17, . . . , which shows the configuration of the connectors 14 (14a and 14b) that laterally connect conventional PTA sub-modules 1. FIG. 2A is a cross-sectional view in which the connector 14a is a double-sided contact connector, while FIG. 2B is a cross-sectional view in which the connector 14b is configured as a flexible cable with relay connectors.

In the configuration shown in FIG. 2A, at the end portions of adjacent PTA sub-modules, the display electrodes 10 and 10 supported on the inner surface of the front-side flexible supporting sheets FF respectively, are bent toward the rear side along the end portions of the plasma tube arrays so as to face each other back to back, with the flexible supporting sheets FF being interposed therebetween, and the end portions of the respective X electrodes and Y electrodes are inserted into the connector 14a to be held therein. Furthermore, metal coated frames 19 and 19 of the respective PTA sub-modules to serve as ground electrodes are connected to each other with a ground cable 20, so that the ground potential is commonized between the PTA sub-modules 1 and 1. In the same manner, in the configuration shown in FIG. 2B, the display electrodes 10 and 10 of adjacent PTA sub-modules 1 and 1 are bent toward the rear side along the end portions of the plasma tube arrays. The bent end portions of the display electrodes 10 and 10 are inserted into input-side connecting ports of the connectors 14b and 14b together with the front-side flexible supporting sheets FF, respectively. The output-side connecting ports of the connectors 14b and 14b are connected to each other with a flexible cable 21 composing the same number of connecting lines as that of the display electrodes 10. Further, the metal coated frames 19 and 19 of the respective PTA sub-modules to serve as ground electrodes are connected to each other with the ground cable 20, so that the ground potential is commonized between the PTA sub-modules 1 and 1.

However, when a PTA system module for a large screen is composed of a plurality of PTA sub-modules 1, 1, . . . connected laterally to one another, it is necessary to clearly distinguish among the right PTA sub-module 1a to be connected to the X drive circuit 12, the left PTA sub-module 1c to be connected to the Y drive circuit 13, and the center PTA sub-module 1b to be located at the center and to be connected to adjacent left and right PTA sub-modules 1a and 1c. Furthermore, there has been a problem in that even when a failure occurs in only one of the PTA sub-modules 1a, 1b, and 1c after the PTA system module is assembled, it can be replaced only with the same type of the PTA sub-module 1a, 1b, or 1c and therefore maintenance is troublesome.

Moreover, in the case where at least two PTA sub-modules 1 and 1 are connected laterally to each other, in the conventional configuration in which the display electrodes for X electrodes and Y electrodes are connected to each other between adjacent PTA sub-modules 1 and 1, although both the gap between adjacent terminals of the connector 14a and the gap between adjacent terminals of the connector 14b are minute, as small as 1 mm or smaller, it is necessary to satisfy withstand voltage characteristics that a maximum potential difference between the X electrode and the Y electrode is 600V or more. Therefore, in order to satisfy the withstand voltage characteristics, the connectors 14a and 14b are required to have costly configurations.

### SUMMARY OF THE INVENTION

The present invention was made with such situations in mind. The present invention is intended to provide plasma tube array-type display sub-modules (PTA sub-modules), which are commonized so as to allow a universal design, and a display device configured with a plurality of the PTA sub-modules connected to one another. Furthermore, the present invention is intended to provide a new connection structure in which a standard connector with a low withstand voltage can be used for the connection between the PTA sub-modules.

In order to achieve the above-mentioned objects, a PTA sub-module according to a first invention comprises a plasma tube array including a plurality of plasma tubes arranged in parallel on a front-side supporting sheet, and a plurality of display electrode pairs formed, each of which includes a first electrode and a second electrode that extend in the direction crossing each of the plasma tubes, on the front-side supporting sheet wherein the PTA sub-module further comprises connection boards, on each of which a first connector connected to the first electrode and a second connector connected to the second electrode are provided separately in the direction in which display electrodes extend, at both ends of the front-side supporting sheet in the direction in which the display electrodes extend.

In the first invention, the connections between the first electrodes and between the second electrodes of adjacent PTA sub-modules as well as between the first electrodes or the second electrodes and drive circuits become easy. Furthermore, since the connectors that connect the first electrodes and the second electrodes are provided separately, the intervals between adjacent terminals of each connector can be large. Moreover, since adjacent terminals have the same type of electrode potential, it is sufficient for the connectors to have a withstand voltage as low as the scanning voltage. That is, according to the first invention, it is not necessary to alter the arrangement pattern of the display electrodes according to the arrangement of the PTA sub-modules, and the connectors for connecting between the display electrodes as well as the connection boards provided with the connectors can be commonized to have a lower withstand voltage. Accordingly, production costs can be reduced significantly and thus inexpensive display devices can be provided. Furthermore, the PTA sub-modules are flexibly replaceable and therefore the number of maintenance steps also can be reduced.

The term “plasma tube array-type display sub-module (PTA sub-module)” denotes a display component as described above including a plasma tube array in which a display screen of, for example, one meter square is considered as one unit, and it denotes a semifinished product of a display panel that does not include, for example, a power supply circuit. Furthermore, the term “plasma tube array-type display system module (PTA system module)” denotes a system module that composes one display panel with a plurality of PTA sub-modules being connected laterally and/or vertically to one another through, for example, predetermined connectors, and it denotes a system component that composes a display device when, for example, an X drive circuit, a Y drive circuit, an address drive circuit, and a power supply circuit are connected thereto.

A PTA sub-module according to a second invention is characterized in that in the first invention, the both connection boards connected the display electrode pairs are mounted on a rear side of the plasma tube array-type display sub-module, on the connection board provided at one end of the front-side supporting sheet, the first connector is provided in a position further away from the plasma tube located outermost on the side of the one end than the second connector, and on the connection board provided at the other end of the front-side supporting sheet, the first connector is provided in a position further away from the plasma tube located outermost on the side of the other end than the second connector.

In the second invention, the first connector to which the first electrodes are connected is provided always in a position away from the plasma tube located outermost of the PTA sub-module (on the outer side) on the connection boards provided at both ends of the PTA sub-module, while the second connector to which the second electrodes are connected is provided always in a position close to the plasma tube located outermost of the PTA sub-module (on the inner side) on the connection boards provided at both ends of the PTA sub-module. Therefore, when a plurality of PTA sub-modules are to be connected laterally (i.e. a joining direction that intersects the direction in which the plasma tubes extend) to one another, a cable that connects the same type of connectors located on the inner side to each other can be arranged on top of a cable that connects the same type of connectors located on the outer side to each other, reliable connections can be obtained without bending the connection cables, and the gap between adjacent PTA sub-modules can be minimized. Furthermore, even when operations are repeated including, for example, disassembling an assembled PTA system module into a plurality of PTA sub-modules and reconstructing one PTA system module, the first connectors, the second connectors, and the display electrodes do not cause excessive loads, and for example, damage to the first connectors and/or the second connectors, damage to the connection boards, and deformation of the display electrodes, which result from the excessive loads, can be avoided. Thus it is possible to provide high quality display devices with a lower possibility of causing, for example, disconnection.

Furthermore, a PTA sub-module according to a third invention is characterized in that in the second invention, the first electrode is a X electrode that is used as a scanning electrode, the second electrode is an Y electrode that is used as a common electrode, and on each of the connection boards provided at the one end and the other end, the first connector connected to the X electrode is provided in a position further away from the plasma tube located outermost on each of the sides of the one end and the other end than the second connector connected to the Y electrode.

In the third invention, the first electrode is an X electrode that is used as a scanning electrode and the second electrode is a Y electrode that is used as a common electrode, and on each of the connection boards provided at one end and the other end, the first connector connected to the X electrode is provided in a position further away from the plasma tube located outermost than the second connector connected to the Y electrode. Accordingly, the cable for connecting the Y electrodes between the adjacent PTA sub-modules can be short and therefore the line resistance can be reduced.

Furthermore, a PTA sub-module according to a fourth invention is characterized in that in the first invention, the both connection boards connected the display electrode pairs are mounted on a rear side of the plasma tube array-type display sub-module, on the connection board provided at one end of the front-side supporting sheet, the second connector is provided in a position further away from the plasma tube located outermost on the side of the one end than the first connector, and on the connection board provided at the other end of the front-side supporting sheet, the first connector is provided in a position further away from the plasma tube located outermost on the side of the other end than the second connector.

In the fourth invention, the first connectors, to which the first electrodes are connected, are provided on the outer side on the connection board provided at one end of the PTA sub-module and on the inner side on the connection board provided at the other end, and the second connectors, to which the second electrodes are connected, are also provided on the inner side on the connection board provided at one end of the PTA sub-module and on the outer side on the connection board provided at the other end. Therefore, when the PTA sub-modules are to be connected laterally to one another, the cables for connecting the same type of electrodes to each other between adjacent PTA sub-modules connect outer-side connectors to inner-side connectors with respect to both connectors for connecting the X electrodes and those for connecting the Y electrodes. Accordingly, the length of the connection cables can be conformed. Thus, production costs can be reduced further, reliable connections can be obtained without bending the connection cables, and the gap between adjacent PTA sub-modules can be minimized. In this case, the connection boards provided at both left and right ends of the front-side supporting sheet can also be commonized with the same configuration, which can be used at either end by being rotated 180 degrees.

Moreover, a PTA sub-module according to a fifth invention is characterized in that in the fourth invention, the connection board provided at one end of the front-side supporting sheet has the same configuration as that of the connection board provided at the other end, the first electrode and the second electrode arranged alternately are connected to the first connector and the second connector, respectively, on the connection board provided at the one end, and the first electrode and the second electrode are connected to the second connector and the first connector, respectively, on the connection board provided at the other end.

In the fifth invention, the first connection board provided at one end of the front-side supporting sheet has the same configuration as that of the second connection board provided at the other end. On the first connection board, the first electrode and the second electrode that are arranged alternately are connected to the first connector and the second connector, respectively. On the second connection board, the first electrodes and the second electrodes are connected to the second connector and the first connector, respectively. Thus, the connection boards provided at both left and right ends of the front-side supporting sheet can also be commonized with the same configuration, which can be used at either end by being rotated 180 degrees. Moreover, since the number of types of the flexible cables to be connected can be reduced, production costs can be reduced significantly, and thus inexpensive display devices can be provided.

Furthermore, a PTA sub-module according to a sixth invention is characterized in that in any one of the first to fifth inventions, a first wiring conductor that connects the first connector to the first electrode and a second wiring conductor that connects the second connector to the second electrode are provided separately on the front and rear sides of the connection wiring board.

In the sixth invention, the first connector and the second connector are provided separately on one face of a wiring board, and the first wiring conductor that connects the first connector to the first electrodes and the second wiring conductor that connects the second connector to the second electrodes are provided separately on the front and rear sides of the connection wiring board. Accordingly, no short circuit occurs between the first wiring conductor and the second wiring conductor and thereby they can be connected to the two connectors reliably.

Next, in order to achieve the aforementioned objects, a display device according to a seventh invention is characterized in that a plurality of PTA sub-modules according to any one of the first to sixth inventions are arranged in the direction that intersects the direction in which the plasma tubes extend, and a flexible cable connecting between the same type of connectors at adjacent end portions of the adjacent PTA sub-modules.

In the seventh invention, since a plurality of PTA sub-modules with the universal configurations in any one of the first to sixth inventions are connected to one another, it is not necessary to alter the arrangement pattern of the display electrodes according to the arrangement of the PTA sub-modules, and the connectors for connecting between the display electrodes as well as the connection boards provided with the connectors can be commonized. Accordingly, production costs can be reduced significantly and inexpensive large-screen display devices can be provided. Furthermore, the PTA sub-modules are flexibly replaceable and therefore the number of maintenance steps also can be reduced.

As described above, according to the configuration of the present invention, the PTA sub-modules have a universal configuration. Therefore, when a plurality of PTA sub-modules are connected to one another to configure a large screen, it is not necessary to prepare PTA sub-modules with arrangement patterns of the display electrodes altered according to the arrangement thereof, and the connectors for connecting between the display electrodes as well as the connection boards provided with the connectors can be commonized. Accordingly, production costs can be reduced significantly and thereby inexpensive display devices can be provided. Furthermore, since the configuration is employed in which the connectors on the X electrode side and the Y electrode side are separated from each other by using a relay multilayer wiring substrate, the withstand voltage required for the connectors can be lowered significantly. Moreover, the PTA sub-modules can be flexibly replaceable and therefore the number of maintenance steps also can be reduced.

### BRIEF DESCRIPTION OF THE DRAWINGS

FIGS. 1A, 1B, and 1C each are a schematic view showing a connection state of conventional PTA sub-modules.

FIGS. 2A and 2B each are a cross-sectional view, on the face orthogonal to the longitudinal direction of plasma tubes, showing the configurations of the connectors that laterally connect conventional PTA sub-modules.

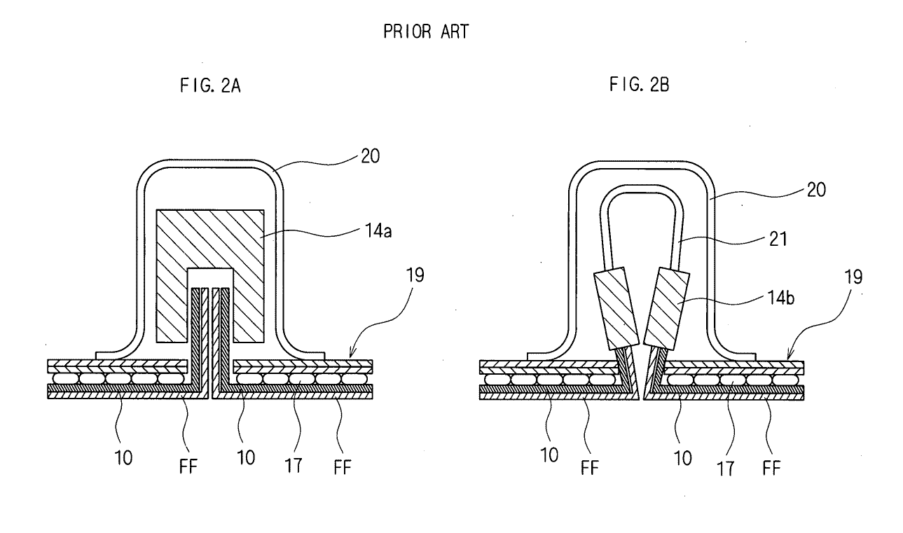

FIGS. 3A to 3C are perspective views that schematically show the configuration of a PTA sub-module that is used for a display device according to Embodiment 1 of the present invention.

FIGS. 4A to 4C are schematic views, each of which shows the outline of the connection state of the PTA sub-modules according to Embodiment 1 of the present invention.

FIG. 5 is a plan view, viewed from the rear side, that schematically shows the configuration of the connection boards for laterally connecting the PTA sub-modules according to Embodiment 1 of the present invention.

FIG. 6 is a plan view schematically showing the state where the PTA sub-modules according to Embodiment 1 of the present invention are connected laterally to one another.

FIG. 7 is a cross-sectional view, on the face orthogonal to the longitudinal direction of the plasma tubes, showing a configuration example in which the PTA sub-modules according to Embodiment 1 of the present invention are connected laterally to one another.

FIGS. 8A and 8B each are an enlarged cross-sectional view, on the face orthogonal to the longitudinal direction of the plasma tubes, showing a configuration example of the vicinities of connection boards that laterally connect the PTA sub-modules according to Embodiment 1 of the present invention to each other.

FIG. 9 is a plan view, viewed from the rear side, that schematically shows the configurations of connection boards for laterally connecting the PTA sub-modules according to Embodiment 2 of the present invention to each other.

FIG. 10 is a plan view that schematically shows the state where the PTA sub-modules according to Embodiment 2 of the present invention are connected laterally to one another.

FIG. 11 is a partial plan view that schematically shows a unit connection configuration for connecting terminals where the electrodes are brought together as one group in the case where the PTA sub-modules according to Embodiment 2 of the present invention are connected laterally to one another.

FIGS. 12A and 12B are illustrations showing the case where a plurality of PTA sub-modules according to Embodiment 1 and those according to Embodiment 2 are connected to one another to compose a PTA system module, respectively.

### BEST MODE FOR CARRYING OUT THE INVENTION

Hereinafter, plasma tube array-type display sub-modules (PTA sub-modules) according to embodiments of the present invention are described in detail with reference to the drawings.

### Embodiment 1

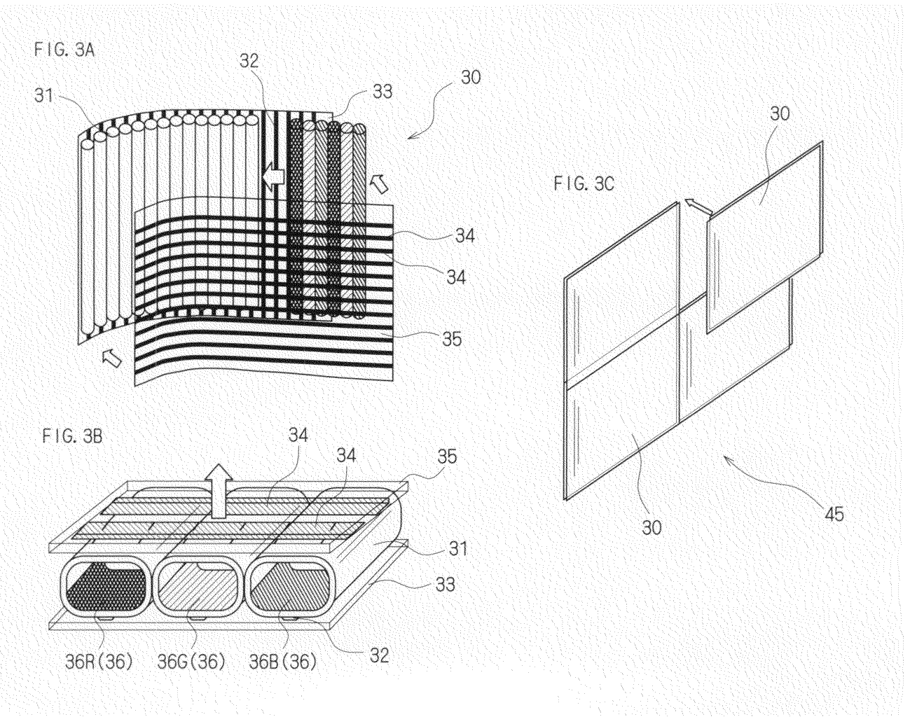

FIG. 3A is a perspective view that schematically shows the configuration of the PTA sub-module. FIG. 3B is a perspective view that partially shows the configuration of the PTA sub-module. FIG. 3C is a perspective view showing a PTA system module in which PTA sub-modules are connected in a matrix.

As shown in FIG. 3A, the PTA sub-module 30 includes a plurality of plasma tubes 31, 31, . . . arranged in parallel, each of which is filled with a discharge gas. The plasma tubes 31, 31, . . . are discharging thin tubes. The diameter of each tube to serve as a tube body is not particularly limited but is desirably about 0.5 to 5 mm. As an example, a 1 square-meter PTA sub-module 30 is configured with 1000 glass thin tubes arranged in parallel as sets of a plurality of glass thin tubes, each of which has an oblate ellipsoid cross-section with a diameter of 1 mm and a length of 1 m. Each thin tube may have any shape of cross-section, such as a circular cross-section, oblate ellipsoid cross-section, or square cross-section. Furthermore, the plasma tubes 31, 31, . . . are filled with a discharge gas such as neon, xenon and the like at a predetermined ratio and a predetermined pressure.

The plurality of plasma tubes 31, 31, . . . arranged in parallel are held between a rear-side supporting sheet 33 and a front-side supporting sheet 35. The rear-side supporting sheet 33 comprises address electrodes 32, 32, . . . provided to be in contact with the lower surface in the longitudinal direction of each plasma tube 31. The front-side supporting sheet 35 comprises display electrodes 34, 34, . . . provided in the direction crossing the upper surface in the longitudinal direction of each plasma tube 31. The front-side supporting sheet 35 is a flexible sheet and is configured with, for example, a polycarbonate film or a PET (polyethylene terephthalate) film.

A plurality of display electrodes 34, 34, . . . are arranged in a stripe pattern on the inner surface of the front-side supporting sheet 35. They are in contact with each plasma tube 31 in such a manner as to cross the upper surface thereof. Adjacent display electrodes 34 and 34 configuring a display electrode pair serve as an X electrode and a Y electrode, and a display discharge is generated inside the plasma tubes 31, 31, . . . between the X electrode and the Y electrode. The display electrodes 34 can be formed in an arrangement pattern known in the present field, such as a mesh pattern, a ladder pattern, or a comb teeth pattern, in addition to a stripe pattern. Furthermore, examples of the material that is used for the display electrodes 34 include transparent conductive materials such as ITO (indium tin oxide) and SnO₂ and metal conductive materials such as Ag, Au, Al, Cu, and Cr.

Various methods known in the present field can be used for the method of forming the display electrodes 34. For example, they may be formed using a thick-film forming technique such as printing or may be formed using a thin-film forming technique that includes a physical deposition method or a chemical deposition method. One example of the thick-film forming techniques is a screen printing method. Among the thin-film forming techniques, examples of the physical deposition method include a vapor deposition method and a sputtering method. Examples of the chemical deposition method include a thermal CVD method, a photo-CVD method, and a plasma CVD method.

The address electrodes 32, 32, . . . each are provided per plasma tube 31 on the upper surface of the rear-side supporting sheet 33 located on the rear face of the PTA sub-module 30 along the longitudinal direction of the plasma tubes 31, 31, . . . . The address electrodes 32, 32, . . . form light-emitting cells at intersections with the paired display electrodes 34, 34, . . . . The address electrodes 32 also can be formed using various materials and methods that are known in the present field.

In the above-described configuration, when the PTA sub-module 30 serves as one for color display, as shown in FIG. 3B, each plasma tube 31 comprises a red (R) phosphor layer 36R, a green (G) phosphor layer 36G, or a blue (B) phosphor layer 36B. When one pixel is configured with one set of plasma tubes 31, 31, and 31 of three colors RGB, the PTA sub-module 30 can serve as one for color display. In the case of the red (R) phosphor layer 36R, a phosphor material such as (Y, Gd)BO₃ :Eu³⁺ that emits red light by ultraviolet irradiation is used for the phosphor layer 36. In the case of the green (G) phosphor layer 36G, a phosphor material such as Zn₂SiO₄:Mn that emits green light is used, while in the case of the blue (B) phosphor layer 36B, a phosphor material such as BaMgAl₁₂O₁₇:Eu²⁺ that emits blue light is used. In this case, in order to increase the flexibility of the PTA sub-module 30 and to facilitate the assembly, it is preferable that plasma tube units are formed, in each of which a set of three or its few times plasma tubes of three colors RGB is bonded to a strip-shaped rear-side supporting sheet 33, and a plurality of plasma tube units are bonded commonly to the front-side supporting sheet 35 to produce a PTA sub-module 30 for a color display is produced.

FIG. 3C is a perspective view that schematically shows a PTA system module 45 in which the above-mentioned PTA sub-modules 30 are connected to one another in a matrix. In FIG. 3C, one PTA system module 45 for a large screen is composed of four PTA sub-modules 30, 30, . . . , and each PTA sub-module 30 is a semifinished product that does not include, for example, a drive circuit or a power supply circuit. In the stage where the PTA system module 45 for a large screen is composed, for example, the drive circuit and the power supply circuit are incorporated thereinto, regarding the whole as one display film. This makes it possible to configure a large-screen display device with less variations in quality of display images among the PTA sub-modules 30, 30, . . . . The PTA sub-modules 30 and 30 connected laterally can commonly be driven when their display electrodes 34 and 34 are connected to each other with the connection configuration of the present invention. With respect to the PTA sub-modules 30 and 30 connected vertically to each other, when the address electrodes 32 and 32 of each of them are led out to the front and rear sides of the screens to be connected to an address drive circuit, a screen of the two upper-side PTA sub-modules 30 and 30 and a screen of the two lower-side PTA sub-modules 30 and 30 can be driven in parallel by a known so-called “dual scan technique”, with the address electrodes 32 and 32 not being connected to each other.

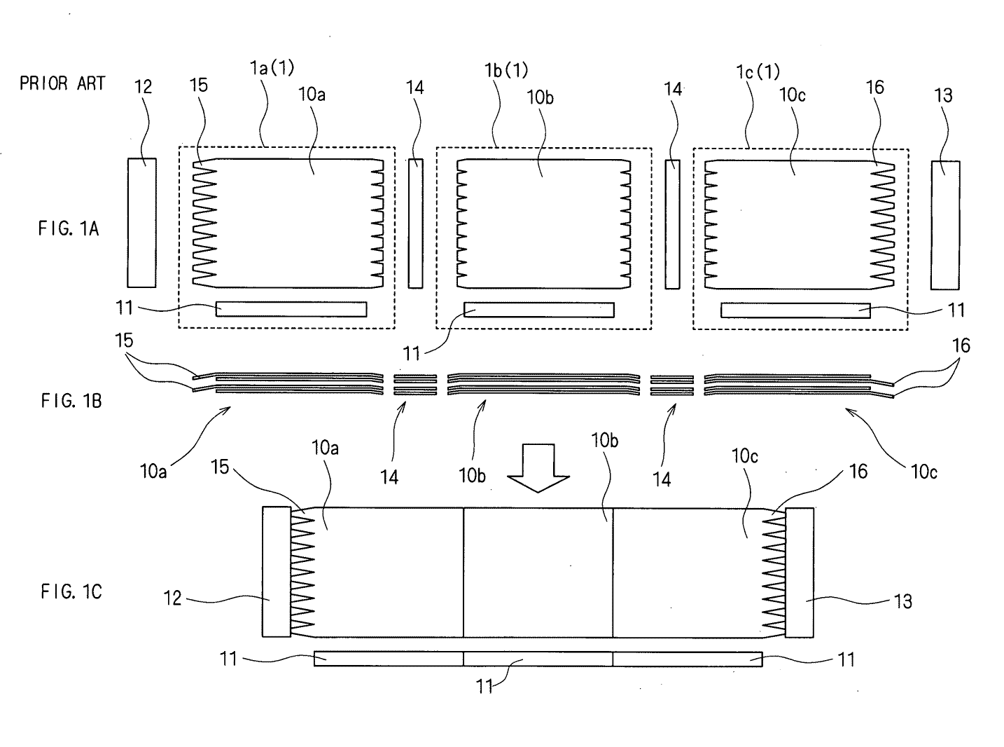

When the conventional PTA sub-modules 1, 1, . . . are to be connected laterally to each other, as described with reference to FIG. 1A, it is necessary to prepare three types of PTA sub-modules: a left PTA sub-module 1a comprising display electrodes 10a with an arrangement pattern in which the X electrode terminals are led out longer at one end so as to be connected to the X drive circuit 12, a center PTA sub-module 1b comprising display electrodes 10b with an arrangement pattern in which the X electrodes and the Y electrodes are led out to the same position so that adjacent PTA sub-modules are connected to each other, and a right PTA sub-module 1c comprising display electrodes 10c with an arrangement pattern in which the Y electrode terminals are led out longer at one end so as to be connected to the Y drive circuit 13.

However, it is necessary to clearly distinguish the types of the PTA sub-modules 1, 1, . . . to determine their arrangement when a PTA system module 45 for a large screen is to be composed and thereby the work efficiency is decreased. Furthermore, when a failure occurs in any one of the PTA sub-modules 1a, 1b, and 1c, it can be replaced only with the same type of the PTA sub-module 1a, 1b, or 1c. Therefore, the PTA sub-module 1 cannot be used flexibly in any position.

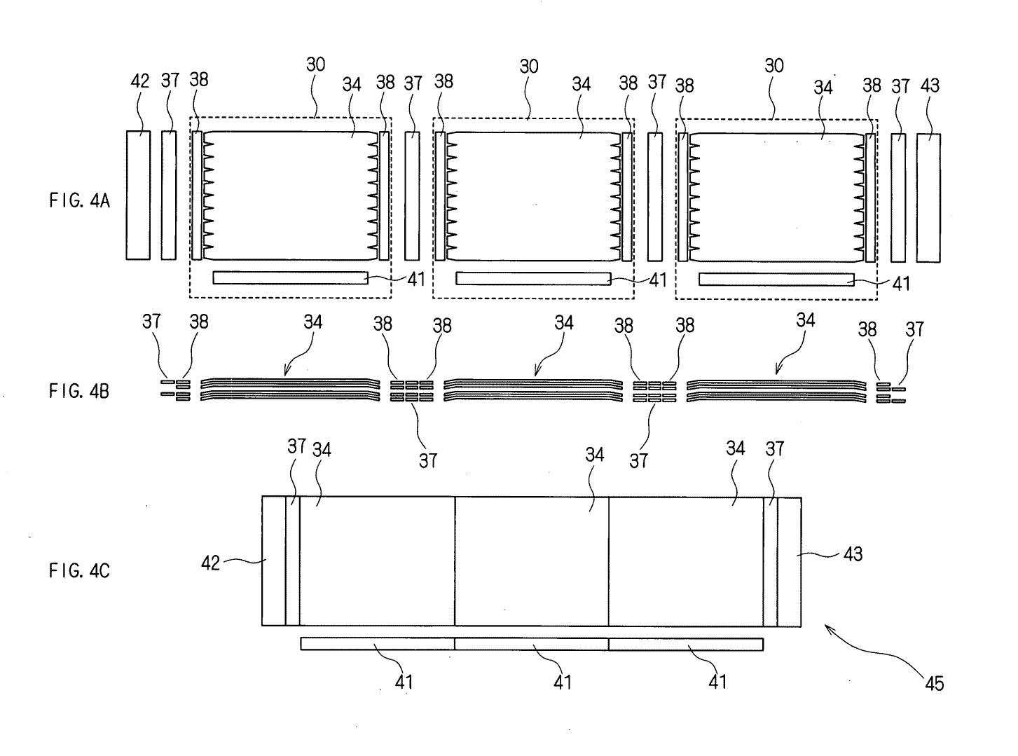

Therefore, in the present invention, all the arrangement patterns of the display electrodes 34, 34, . . . of the PTA sub-modules 30, 30, . . . are commonized, and additionally, relay connection boards provided with two connectors are used, which results in a configuration that allows the PTA sub-modules 30, 30, . . . to be connected flexibly to each other as required without depending on the arrangements of the PTA sub-modules 30. FIGS. 4A to 4C are schematic views, each of which shows the outline of the connection state of the PTA sub-modules 30, 30, . . . according to Embodiment 1 of the present invention.

FIG. 4A is a schematic plan view that shows the outline in the case where the PTA sub-modules 30, 30 and 30 according to Embodiment 1 of the present invention are connected laterally to each other. As shown in FIG. 4A, the PTA sub-modules 30, 30 and 30 are configured with display electrodes 34, 34 and 34 and address drive circuit boards 41, 41 and 41. The display electrodes 34, 34 and 34 are formed respectively in a common arrangement pattern of electrodes. The address drive circuit boards 41, 41 and 41 individually select address electrodes 32, 32 and 32 corresponding to the respective plasma tubes formed on the inner surface of the rear-side supporting sheet 33 of the plasma tube array.

FIG. 4B is a schematic view showing a part of the forming pattern of the display electrodes 34, 34 and 34. As shown in FIG. 4B, the display electrodes 34, 34 and 34 are configured with a plurality of display electrode pairs of adjacent X electrode and Y electrode. The display electrodes 34 are formed so that the left PTA sub-module 30 to be connected to an X drive circuit 42, the right PTA sub-module 30 to be connected to a Y drive circuit 43, and the PTA sub-module 30 arranged in the center all have the same length and the same arrangement pattern of the electrodes. As shown in FIG. 4A, the display electrodes 34 each have a configuration in which terminals are formed by making, for example, 16 pairs of electrodes into one group, in both end portions of the front-side supporting sheet 35, and a plurality of pairs of electrodes are connected to a connector as one unit.

As described above, the PTA sub-modules 30 of the present invention include display electrodes 34, 34 and 34 comprising the same arrangement pattern despite the arrangement of the PTA sub-modules 30. Furthermore, as described later, each PTA sub-module 30 includes common connection boards 38, with a connector for X electrodes and a connector for Y electrodes provided for each of the left and right terminals of the display electrode 34, and cables 37 connect between the same types of connectors. Thus, one PTA system module 45 for a large screen is composed (see FIG. 4C).

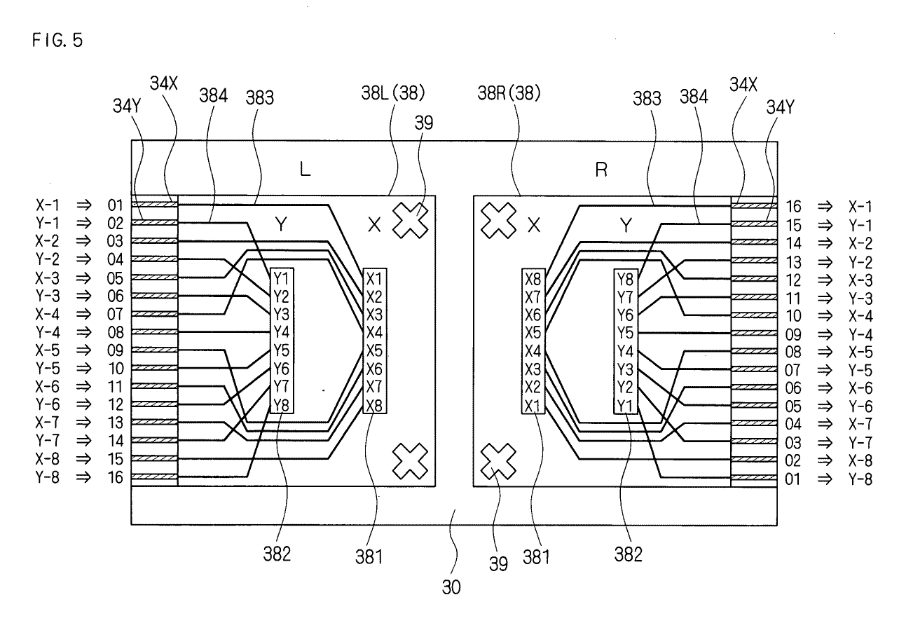

The connection boards 38 are fixed to both end portions on the rear side of each PTA sub-module 30 and are connected to the display electrodes 34 and 34. FIG. 5 is a plan view, viewed from the rear side, that schematically shows the configuration of the connection boards 38 and 38 for laterally connecting the PTA sub-modules 30 according to Embodiment 1 of the present invention.

The connection board 38L is mounted at the left end of the rear frame of the PTA sub-module 30 by fixing means 39 such as screws. Similarly, the connection board 38R is mounted at the right end of the rear frame by fixing means 39. On the other hand, in the display electrodes 34, 34, . . . formed on the inner surface of the front-side supporting sheet 35 of the PTA sub-module 30, for example, 16 pairs, that is 32 pieces of X electrodes and Y electrodes are combined to be led out as one group at the left and right terminals. In FIG. 5, eight pieces of X electrodes 34X, 34X, . . . and eight pieces of Y electrodes 34Y, 34Y, . . . , which are shown representatively for convenience, are bent toward the rear side together with the front-side supporting sheet 35 at both ends of the PTA sub-module 30 and are connected to input contact points of the connection boards 38L and 38R, respectively.

Eight pieces of X electrodes 34X, 34X, . . . and eight pieces of Y electrodes 34Y, 34Y, . . . are connected alternately to electrode Nos. 01 to 16 of the input contact points of the connection board 38L. Eight pieces of X electrodes 34X, 34X, . . . and eight pieces of Y electrodes 34Y, 34Y, . . . are connected to odd electrode numbers and even electrode numbers, respectively. The connection board 38L includes a first connector 381 and a second connector 382. Eight pieces of X electrodes 34X, 34X, . . . placed at the odd numbers from the top are combined to be connected to the first connector 381. Eight pieces of Y electrodes 34Y, 34Y, . . . placed at the even numbers from the top are combined to be connected to the second connector 382. The two connectors 381 and 382 are arranged away from each other in the direction in which the display electrodes 34 extend. In FIG. 5, the first connector 381 for the X electrodes is located on the inner side of the PTA sub-module 30 (on the side away from the plasma tube 31 located furthest to the left) comparing with the second connector 382 for the Y electrodes.

On the other hand, the connection board 38R comprises a configuration obtained by rotating the connection board 38L 180 degrees to reverse the front and rear sides. Eight pieces of X electrodes 34X, 34X, . . . connected to the input contact points of the even electrode numbers are combined to be connected to the first connector 381 of the connection board 38R. Eight pieces of Y electrodes 34Y, 34Y, . . . connected to the input contact points of the odd electrode numbers are combined to be connected to the second connector 382. As in the case of the connection board 38L, the first connector 381 for the X electrodes is located on the inner side of the PTA sub-module 30 (on the side away from the plasma tube 31 located furthest to the right) comparing with the second connector 382 for the Y electrodes.

When the X electrodes 34X, 34X, . . . and the Y electrodes 34Y, 34Y, . . . are combined to be connected in this manner, respectively, connecting pins (not shown in the figures) in the first connectors 381 for the X electrodes and the second connectors 382 for the Y electrodes have the same electrode potentials, respectively. Therefore, the withstand voltage required between the connecting pins can be lowered significantly. Accordingly, inexpensive products with lower withstand voltages can be employed for all the first connectors 381, the second connectors 382, and the cables 37 that connect between the first connectors 381 and 381 and between the second connectors 382 and 382. Consequently, the total cost of the display device can be reduced.

Furthermore, no ground electrodes are arranged on the connection boards 38L and 38R. Therefore, the size of the connection boards 38L and 38R can be reduced and the degree of freedom for arranging the first connectors 381 and the second connectors 382 is improved. This results in various configurations of connections to be made using the cables 37.

On the connection boards 38L and 38R, the input contact points to be connected to eight pieces of X electrodes 34X, 34X, . . . are connected to the first connectors 381 through printed wiring conductors 383, while the input contact points to be connected to eight pieces of Y electrodes 34Y, 34Y, . . . are connected to the second connectors 382 through printed wiring conductors 384. With respect to the X and Y printed wiring conductors 383 and 384, it is preferable that wirings are separated on the front and rear sides of the connection boards 38L and 38R to be multilayered. This is because in that case there is no possibility of causing a short circuit and the size of the connection boards 38L and 38R further can be reduced. When the wirings are to be multilayered, they may be connected to one connector through a through hole as required. That is, the important point is to connect one line of input contact points of the XY electrodes to X-Y separated two lines of connectors on the connection boards 38L and 38R.

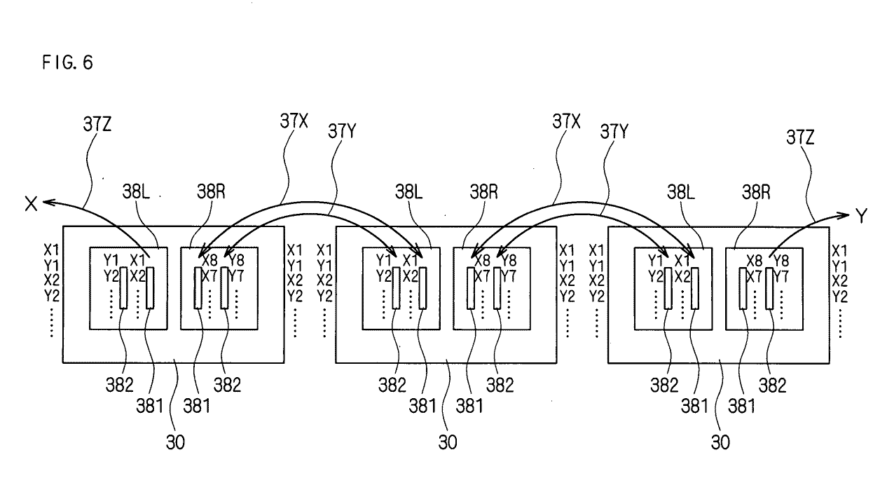

FIG. 6 is a plan view schematically showing the state where the PTA sub-modules 30, 30 and 30 according to Embodiment 1 of the present invention are connected laterally to one another. The first connector 381 of the connection board 38R of one PTA sub-module 30 and the first connector 381 of the connection board 38L of adjacent PTA sub-module 30 are connected to each other with a flexible cable 37X for connecting X electrodes. The second connector 382 of the connection board 38R of one PTA sub-module 30 and the second connector 382 of the connection board 38L of adjacent PTA sub-module 30 are connected to each other with a flexible cable 37Y for connecting Y electrodes.

In the leftmost PTA sub-module 30 to be connected to the X drive circuit 42, the first connector 381, to which eight pieces of X electrodes 34X, 34X, . . . are combined to be connected, and the X drive circuit 42 are connected to each other with a flexible cable 37Z. In the rightmost PTA sub-module 30 to be connected to a Y drive circuit 43, the second connector 382, to which eight pieces of Y electrodes 34Y, 34Y, . . . are combined to be connected, and the Y drive circuit 43 are connected to each other with a flexible cable 37Z. Therefore, flexible cables to be prepared are three types of cables with different lengths: the flexible cables 37X for connecting between the first connectors 381 and 381, the flexible cables 37Y for connecting between the second connectors 382 and 382, and the flexible cables 37Z for connecting the first connector 381 or the second connector 382 to the X drive circuit 42 or the Y drive circuit 43. In this case, the flexible cables 37Y for connecting Y electrodes to serve as scanning electrodes to each other can be shorter than the cables 37X. The shorter the connection cables, the less the line resistance. Accordingly, the drive pulses can be transmitted effectively.

Naturally, on the connection boards 38L and 38R, the Y electrodes 34Y, 34Y, . . . can be combined to be connected to the first connectors 381 while the X electrodes 34X, 34X, . . . can be combined to be connected to the second connectors 382. In this case, the connection configuration of the PTA sub-modules 30, 30 and 30 is the same as that shown in FIG. 6, and cables to be prepared are three types of cables with different lengths: the flexible cables 37Y with the length of the flexible cables 37X, the flexible cables 37X with the length of the flexible cables 37Y, and the flexible cables 37Z.

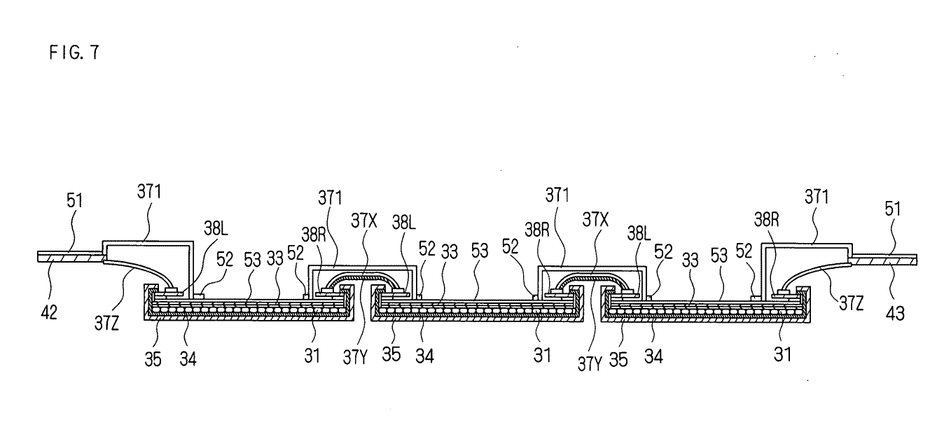

FIG. 7 is a cross-sectional view, on the face orthogonal to the longitudinal direction of the plasma tubes 31, 31, . . . , showing a configuration example, in which the PTA sub-modules 30, 30 and 30 according to Embodiment 1 of the present invention are connected laterally to one another. As shown in FIG. 7, each front-side supporting sheet 35 comprising display electrodes 34, 34, . . . is bent toward the rear side along the end portions of the PTA sub-module 30 including a plurality of plasma tubes 31, 31, . . . , and is connected to the input contact points of the connection boards 38L and 38R by thermal compression method using a conductive adhesive. It is possible to connect between the connection boards 38L and 38R of adjacent PTA sub-modules 30 with a cable 37 (consisting of a set of a ground cable 371 and flexible cables 37X and 37Y). The leftmost connection board 38L and the X drive circuit 42 as well as the rightmost connection board 38R and the Y drive circuit 43 are connected to each other with flexible cables 37Z, respectively.

Furthermore, in order to commonize ground potential, grounded frames 51 and 53 are provided on the rear face of the X drive circuit 42 or Y drive circuit 43 and on the rear face of the PTA sub-modules 30, respectively. The rear frame 53 of each PTA sub-module 30 comprises a configuration in which, for example, a metal conductor film for grounding is formed on the rear face of a reinforced plastic sheet. The frame 51 and a ground connector 52 also are connected to each other with the ground cable 371, so that the ground potentials of all the PTA sub-modules 30, 30, . . . are commonized and thereby a return path for a discharge current that flows from the X drive circuit 42 and the Y drive circuit 43 through the display electrodes 34, 34, . . . is configured. It is not necessary to provide the ground connectors 52 for grounding on the connection boards 38L and 38R. The ground cables 371 can be connected without regard for the interference with the flexible cables 37X and 37Y.

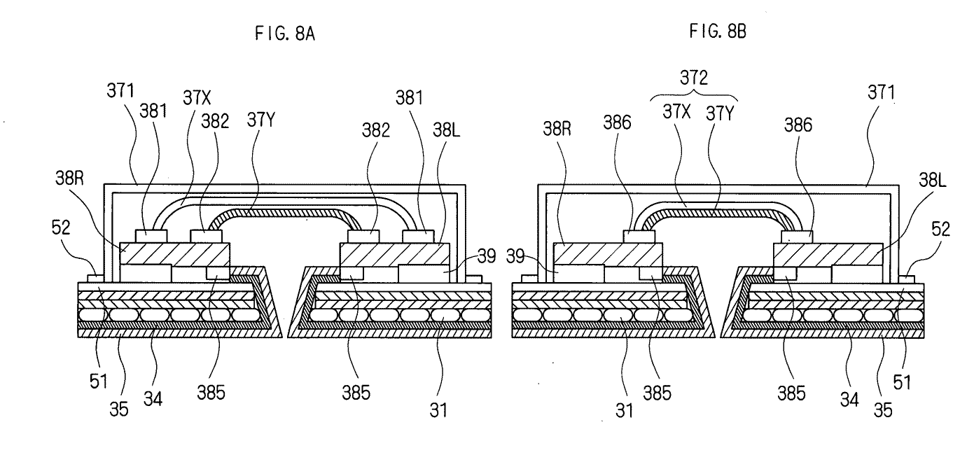

FIGS. 8A and 8B each are an enlarged cross-sectional view, on the face orthogonal to the longitudinal direction of the plasma tubes 31, 31, . . . , showing a configuration example of the vicinities of connection boards 38 that laterally connect the PTA sub-modules 30, 30 and 30 according to Embodiment 1 of the present invention to each other. FIG. 8A shows the case where the connection boards 38L and 38R each are provided with a first connector 381 and a second connector 382. FIG. 8B shows the case where the connection boards 38L and 38R are connected to each other using a flexible cable with a two-layer structure.

In FIG. 8A, the connection boards 38L and 38R are attached onto frames 51 by fixing means 39 such as adhesion or screwing. The end portions of the front-side supporting sheets 35 including the extended ends of the display electrodes 34, 34, . . . formed as a plurality of connector plugs are bent toward the rear side along the end portions of the PTA sub-modules 30 and are inserted into electrode connectors 385 and 385 mounted on the connection boards 38L and 38R to be connected thereto, respectively. The connection boards 38L and 38R each are provided with the first connector 381, the second connector 382, and the printed wiring connecting between the connectors 381, 382 and electrode connectors 385. The ground connectors 52 are not connected onto the connection boards 38L and 38R but are directly connected to the grounding conductors of the frames 51. A ground cable 371 connects between the ground connectors 52, 52, a flexible cable 37X connects between the first connectors 381 and 381, and a flexible cable 37Y connects between the second connectors 382 and 382. Accordingly, both can be connected without causing a short circuit.

In FIG. 8B, in the same manner as shown in FIG. 8A, front-side supporting sheets 35 comprising display electrodes 34, 34, . . . are bent toward the rear side along the end portions of the PTA sub-modules 30 including a plurality of plasma tubes 31, 31, . . . and are connected to the connection boards 38L and 38R using the electrode connectors 385, 385, respectively. The connection boards 38L and 38R are provided with double-sided contact connectors 386 and 386, respectively, in each of which the first connector 381 and the second connector 382 are integrated. The double-sided contact connectors 386 and 386 are connected to each other with a flexible cable 372 having a two-layer structure, that is, a flexible cable 372 in which one layer is a flexible cable 37X and the other layer is a flexible cable 37Y. The use of the flexible cable 372 in which one layer is the flexible cable 37X and the other layer is the flexible cable 37Y can eliminate the possibility of causing a short circuit.

The electrode connectors 385, 385 for input mounted on the connection boards 38L and 38R has a construction of the surface mount type connector or insert pin type connector, respectively, and contact points of them are connected to the first and second connector 381, 382 by the multilayered printed wiring. However, the end portions of the display electrodes 34, 34 may be directly connected by, for example, thermal compression method as in the case of FIG. 7 without using the electrode connectors 385 and 385.

As described above, according to Embodiment 1, it is not necessary to alter the arrangement pattern of the display electrodes 34, 34, . . . according to the arrangement of the PTA sub-modules 30, 30, . . . , and the connectors for connecting between the display electrodes 34 and 34, as well as the connection boards 38 provided with the connectors can be commonized. Therefore, production costs can be reduced significantly and thus inexpensive display devices can be provided. Furthermore, the PTA sub-modules 30, 30, . . . can be flexibly replaceable and therefore the number of maintenance steps also can be reduced.

Moreover, when the PTA sub-modules 30, 30, . . . are to be connected laterally (i.e. a joining direction that intersects the direction in which the plasma tubes 31, 31, . . . extend) to one another, the second connectors 382 and 382 provided on the outer side on the connection boards 38 as well as the first connectors 381 and 381 provided on the inner side on the connection boards 38 are connected to each other with cables 37, respectively. Accordingly, they can be connected to each other reliably without bending the cables 37, and therefore it is possible to minimize the gap between adjacent PTA sub-modules 30 and 30.

Furthermore, even when operations, for example, disassembling the assembled PTA system module 45 into a plurality of PTA sub-modules 30, 30, . . . and reconstructing one PTA system module 45 are repeated, the connectors, the connection boards 38 and the display electrodes 34 are not overloaded, and for example, damage to the connectors and the connection boards as well as deformations of the display electrodes due to overload, can be avoided. Thus it is possible to provide high quality display devices with a lower possibility of causing, for example, disconnection.

### Embodiment 2

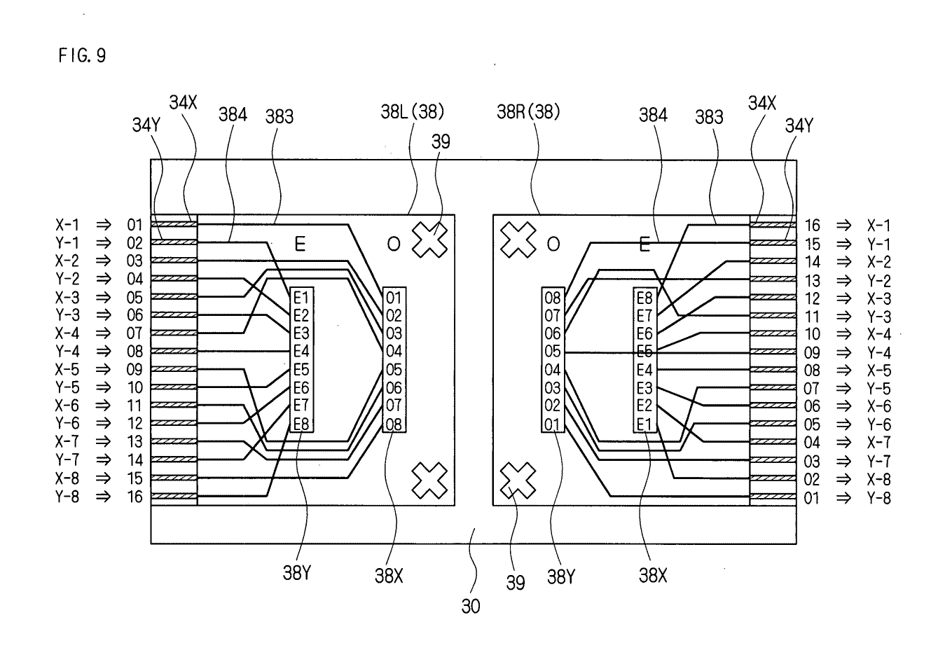

Since the configuration of the PTA sub-module 30 that is used for a display device according to Embodiment 2 of the present invention is basically the same as that of Embodiment 1, the same numbers and symbols are used and detailed descriptions are not repeated. As shown in FIG. 9, Embodiment 2 is different from Embodiment 1 in the configuration for connecting between the first connectors 38X as well as the second connectors 38Y that are provided on the connection boards 38 and 38, respectively, and the X electrodes 34X, 34X, . . . as well as the Y electrodes 34Y, 34Y, . . . that are the display electrodes 34.

That is, in Embodiment 2, one type of connection boards 38 is used in common in the left and right terminals of the display electrodes 34. It is configured in such a manner that the connection board 38L and the connection board 38R are the same type of connection boards 38, one of which has been rotated 180 degrees. As a result, the positional relationship between the first connector 381 and the second connector 382 differs when they are viewed from the plasma tube 31 located outermost of the PTA sub-module 30. FIG. 9 is a plan view, viewed from the rear side, that schematically shows the configurations of the connection boards 38 and 38 for laterally connecting the PTA sub-modules 30 and 30 according to Embodiment 2 of the present invention to each other.

The connection board 38L is mounted at the left end of the rear-side frame of the PTA sub-module 30 by fixing means 39 such as screws. Similarly, the connection board 38R is mounted at the right end of the rear frame by the fixing means 39. The connection boards 38L and 38R are arranged so as to be located on the rear face of the PTA sub-module 30. Eight pieces of X electrodes 34X, 34X, . . . and eight pieces of Y electrodes 34Y, 34Y, . . . that are formed on the surface of the PTA sub-module 30 and that are shown representatively are bent toward the rear side together with the front-side supporting sheet 35 at both ends of the PTA sub-module 30 and are connected to the input contact points of the connection boards 38L and 38R, respectively.

Eight pieces of X electrodes 34X, 34X, . . . and eight pieces of Y electrodes 34Y, 34Y, . . . are connected alternately to the electrode Nos. 01 to 16 of the input contact points of the connection board 38L. Eight pieces of X electrodes 34X, 34X, . . . , and eight pieces of Y electrodes 34Y, 34Y, . . . are connected to odd electrode numbers and even electrode numbers, respectively. Furthermore, the connection board 38L includes a first connector 38X and a second connector 38Y. Eight pieces of X electrodes 34X, 34X, . . . placed at the odd numbers from the top are combined to be connected to the first connector 38X. Eight pieces of Y electrodes 34Y, 34Y, . . . placed at the even numbers from the top are combined to be connected to the second connector 38Y. The two connectors 38X and 38Y are arranged away from each other in the direction in which the display electrodes extend. In FIG. 9, the second connector 38Y is located on the outer side of the PTA sub-module 30 (on the side of the plasma tube 31 located furthest to the left) comparing with the first connector 38X.

On the other hand, the connection board 38R comprises a configuration obtained by rotating the connection board 38L 180 degrees.

Since the electrode Nos. 01 to 16 on the connection boards 38L and 38R remain unchanged, the eight pieces of electrodes 34X, 34X, . . . and eight pieces of Y electrodes 34Y, 34Y, . . . are connected alternately to the electrode Nos. 16 to 01 of the connection board 38R. Eight pieces of X electrodes 34X, 34X, . . . connected to the input contact points of the even electrode numbers are combined to be connected to the first connector 38X of the connection board 38R. Eight pieces of Y electrodes 34Y, 34Y, . . . connected to the input contact points of the odd electrode numbers are combined to be connected to the second connector 38Y. Furthermore, unlike the connection board 38L, the first connector 38X is located on the outer side of the PTA sub-module 30 comparing with the second connector 38Y.

When the X electrodes 34X, 34X, . . . and the Y electrodes 34Y, 34Y, . . . are combined to be connected in this manner, respectively, connecting pins (not shown in the figures) in the first connectors 38X and the second connectors 38Y have the same electrode potentials, respectively. Therefore, the withstand voltage required between the connecting pins can be lowered significantly. Accordingly, inexpensive products with lower withstand voltages can be employed for all the first connectors 38X, the second connectors 38Y, and the cables 37 that connect between the first connectors 38X and 38X and between the second connectors 38Y and 38Y. Consequently, the total cost for the display device can be reduced.

Furthermore, no ground electrodes are arranged on the connection boards 38L and 38R. Therefore, the size of the connection boards 38L and 38R can be reduced and the degree of freedom for arranging of the first connectors 38X and the second connectors 38Y is improved. This results in various configurations of connections to be made using the cables 37.

On the connection boards 38L and 38R, the input contact points to be connected to eight pieces of X electrodes 34X, 34X, . . . are connected to the first connectors 38X through printed wiring conductors 383, while the input contact points to be connected to eight pieces of Y electrodes 34Y, 34Y, . . . are connected to the second connectors 38Y through printed wiring conductors 384. The printed wiring conductors 383 and 384 may be provided with intermediate insulation layer on the same faces of the connection boards 38L and 38R or may be provided separately on the front and rear sides thereof. When they are provided separately on the front and rear sides, there is no possibility of causing a short circuit and the size of the connection boards 38L and 38R further can be reduced.

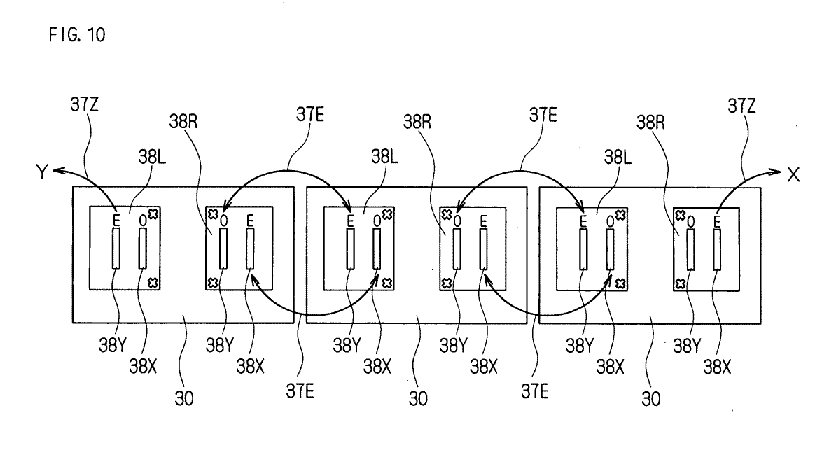

FIG. 10 is a plan view that schematically shows the state where the PTA sub-modules 30, 30 and 30 according to Embodiment 2 of the present invention are connected laterally to one another. When the PTA sub-modules 30, 30 and 30 are connected laterally to one another, the first connector 38X of the connection board 38R of one PTA sub-module 30 and the first connector 38X of the connection board 38L of the adjacent PTA sub-module 30 are connected to each other with a flexible cable 37E for connecting the X electrodes, while the second connector 38Y of the connection board 38R of one PTA sub-module 30 and the second connector 38Y of the connection board 38L of the adjacent PTA sub-module 30 are connected with a flexible cable 37E for connecting the Y electrodes.

Furthermore, in the PTA sub-module 30 located on the side that is connected to an X drive circuit, the first connector 38X, to which eight pieces of X electrodes 34X, 34X, . . . are combined to be connected, and the X drive circuit are connected to each other with a flexible cable 37Z. In the PTA sub-module 30 located on the side that is connected to a Y drive circuit, the second connector 38Y, to which eight pieces of Y electrodes 34Y, 34Y, . . . are combined to be connected, and the Y drive circuit are connected to each other with a flexible cable 37Z. Accordingly, with respect to the flexible cables, the flexible cable 37E for connecting between the first connectors 38X and 38X and the flexible cable 37E for connecting between the second connectors 38Y and 38Y are the cables of the same length. Therefore, unlike Embodiment 1, the cables to be prepared are two types of cables with different lengths: the flexible cables 37E and the flexible cables 37Z for connecting to the X drive circuit or the Y drive circuit.

Naturally, on the connection boards 38L and 38R, the Y electrodes 34Y, 34Y, . . . can be combined to be connected to the first connectors 38X while the X electrodes 34X, 34X, . . . can be combined to be connected to the second connectors 38Y. In this case, the connection configuration of the PTA sub-modules 30, 30 and 30 is also the same as that shown in FIG. 10.

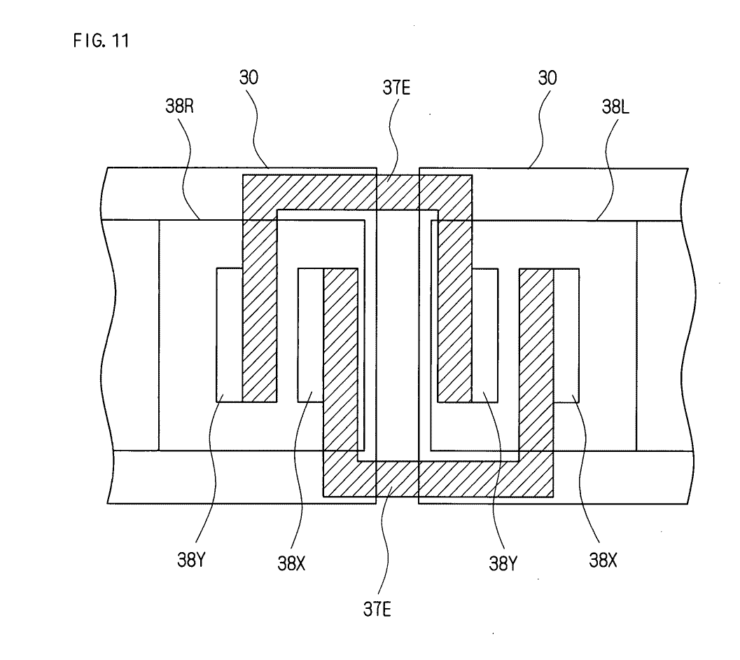

FIG. 11 is a partial plan view that schematically shows a unit connection configuration for connecting terminals where the electrodes are combined as one group in the case where the PTA sub-modules 30 and 30 according to Embodiment 2 of the present invention are connected laterally to each other. As shown in FIG. 11, the connection boards 38R and 38L are connected to each other with flexible cables 37E and 37E. That is, since the use of the linearly shaped flexible cables causes interference and therefore the first connectors 38X and 38X and the second connectors 38Y and 38Y cannot be connected to each other. The interference is avoided by using meandering shaped flexible cables 37E as shown in FIG. 11 so that the first connectors 38X and 38X and the second connectors 38Y and 38Y can be connected to each other with the flexible cables 37E of the same shape. The wiring pitch of each flexible cable 37E is narrower than that in Embodiment 1. However, since the wirings are separated by the types of electrodes to be connected, no problem in manufacturing occurs even when the cable width is half.

As described above, according to Embodiment 2, it is not necessary to alter the arrangement pattern of the display electrodes 34, 34, . . . according to the arrangement of the PTA sub-modules 30, 30, . . . , and the connectors, for connecting between the display electrodes 34 and 34, as well as the connection boards provided with the connectors can be commonized. Moreover, the number of the types of the flexible cables can be reduced. Accordingly, production costs can be reduced significantly and thus inexpensive display devices can be provided. Furthermore, the PTA sub-modules 30, 30, . . . can be flexibly replaceable and therefore the number of maintenance steps also can be reduced.

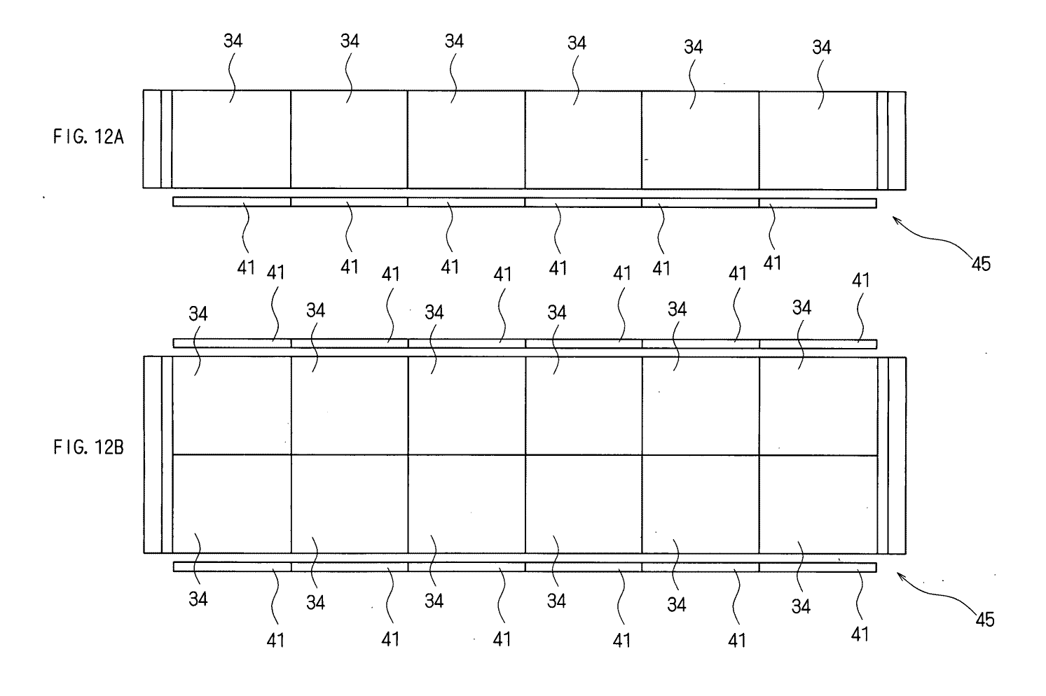

FIGS. 12A and 12B are illustrations showing the case where a plurality of PTA sub-modules 30 according to Embodiment 1 and those according to Embodiment 2 described above are connected to one another to compose a PTA system module 45, respectively. FIG. 12A shows an example of the PTA system module 45 in which the PTA sub-modules 30, 30, . . . are connected laterally to one another. FIG. 12B shows an example of the PTA system module 45 in which the PTA sub-modules 30, 30, . . . are connected to one another in a matrix.

As shown in FIG. 12A, when a plurality of PTA sub-modules 30, 30, . . . are connected laterally to one another, the gap between adjacent PTA sub-modules 30 and 30 corresponds merely to the thickness of two thin front-side supporting sheets 35, and the gap portion is hardly noticeable. Accordingly, it is the equivalent state to that where the display electrodes 34, 34, . . . are arranged continuously.

As shown in FIG. 12B, similarly when a plurality of PTA sub-modules 30, 30, . . . are connected to one another in a matrix, the gap between adjacent PTA sub-modules 30, 30 hardly exists. Therefore, it is the equivalent state to that where the display electrodes 34, 34, . . . are arranged continuously.

There is no upper limit in the number of PTA sub-modules 30, 30, . . . to be connected in a matrix, and the number can be increased or reduced flexibly according to the required screen size. It is obvious that, for example, various deformations and substitutions can be made within the spirit of the present invention.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A plasma tube array-type display sub-module comprising a plasma tube array including a plurality of plasma tubes arranged in parallel on a front-side supporting sheet, and a plurality of display electrode pairs formed, each of which includes a first electrode and a second electrode that extend in the direction crossing each of the plasma tubes, on the front-side supporting sheet wherein
the plasma tube array-type display sub-module further comprises connection boards, on each of which a first connector connected to the first electrode and a second connector connected to the second electrode are provided separately in the direction in which display electrodes extend, at both ends of the front-side supporting sheet in the direction in which the display electrodes extend.

2. The plasma tube array-type display sub-module according to claim, 1, wherein, the both connection boards connected the display electrode pairs are mounted on a rear side of the plasma tube array-type display sub-module,
on the connection board provided at one end of the front-side supporting sheet, the first connector is provided in a position further away from the plasma tube located outermost on the side of the one end than the second connector, and
on the connection board provided at the other end of the front-side supporting sheet, the first connector is provided in a position further away from the plasma tube located outermost on the side of the other end than the second connector.

3. The plasma tube array-type display sub-module according to claim 2, wherein
the first electrode is an X electrode that is used as a common electrode,
the second electrode is a Y electrode that is used as a scanning electrode, and
on each of the connection boards provided at the one end and the other end, the first connector connected to the X electrode is provided in a position further away from the plasma tube located outermost on each of the sides of the one end and the other end than the second connector connected to the Y electrode.

4. The plasma tube array-type display sub-module according to claim 1, wherein, the both connection boards connected the display electrode pairs are mounted on a rear side of the plasma tube array type display sub-module,
on the connection board provided at one end of the front-side supporting sheet, the second connector is provided in a position further away from the plasma tube located outermost on the side of the one end than the first connector, and
on the connection board provided at the other end of the front-side supporting sheet, the first connector is provided in a position further away from the plasma tube located outermost on the side of the other end than the second connector.

5. The plasma tube array-type display sub-module according to claim 4, wherein
the connection board provided at one end of the front-side supporting sheet has the same configuration as that of the connection board provided at the other end,
the first electrode and the second electrode arranged alternately are connected to the first connector and the second connector, respectively, on the connection board provided at the one end, and
the first electrode and the second electrode are connected to the second connector and the first connector, respectively, on the connection board provided at the other end.

6. The plasma tube array-type display sub-module according to any one of claims 1 to 5, wherein
a first wiring conductor that connects the first connector to the first electrode and a second wiring conductor that connects the second connector to the second electrode are provided separately on front and rear sides of the connection board.

7. A plasma tube array-type display sub-module having a configuration in which a plurality of display electrode pairs, each of which includes an X electrode and a Y electrode that extend in the direction crossing each of the plasma tubes arranged in parallel on a front face of a plasma tube array including a plurality of plasma tubes arranged in parallel, wherein
the X electrode and the Y electrode are formed to have the same length on a flexible sheet arranged on the front face of the plasma tube array,
connection boards are mounted at both end portions on a rear face, respectively,
the connection boards each comprise:
an input point that alternately connects extended end portions of the X electrode and Y electrode that are bent toward the rear side together with the flexible sheet,
an X connector and a Y connector provided separately in the direction in which the display electrode pairs extend, and
a wiring conductor that alternately connects the input point of the X electrode and the input point of the Y electrode to the X connector and the Y connector.

8. The plasma tube array-type display sub-module according to claim 7, wherein
a first wiring conductor that connects the X connector to the input point of the X electrode and a second wiring conductor that connects the Y connector to the Y electrode are provided separately on front and rear sides of the connection board.

9. A display device comprising,
a plurality of plasma tube array-type display sub-modules according to any one of claims 1 to 8 arranged in the direction that intersects the direction in which the plasma tubes extend, and a flexible cable connecting between the same type of connectors at adjacent end portions of the adjacent plasma tube array-type display sub-modules.

10. A display device comprising a plurality of plasma tube array-type display sub-modules arranged adjacently in the direction in which display electrode pairs extend, on a front face of a plasma tube array including a plurality of plasma tubes arranged in parallel, having a configuration in which a plurality of the display electrode pairs, each of which includes an X electrode and a Y electrode that extend in the direction crossing each plasma tube, are arranged in parallel, wherein
the X electrode and the Y electrode in each of the plasma tube array-type display sub-modules are formed in the same pattern on a flexible sheet arranged on a front face of each plasma tube array,
connection boards are mounted at both end portions on a rear face of each of the plasma tube array-type display sub-modules, respectively,
the connection boards each comprise:
an input point that alternately connects extended end portions of the X electrode and Y electrode that are bent toward the rear side together with the flexible sheet,
an X connector and a Y connector provided separately in the direction in which the display electrode pairs extend on one surface of the connection board, and
a wiring conductor that alternately connects the input point of the X electrode and the input point of the Y electrode to the X connector and the Y connector, and
a flexible cable connecting between the connectors of the same type on the connection boards located at adjacent end portions in adjacent two of the plasma tube array-type display sub-modules.
